(19) United States
(12) Patent Application Publication
(10) Pub. No.: US 2024/0387160 A1
(43) Pub. Date: Nov. 21, 2024

(54) A SOLID-TARGET COLLISION CELL FOR MASS SPECTROMETRY

(71) Applicants: KIMIA ANALYTICS INC., Richmond Hill (CA); QUADROCORE CORP., Toronto (CA)

(72) Inventors: Gholamreza JAVAHERY, Thornhill (CA); Sina ALAVI, North York (CA); Javad MOSTAGHIMI, Mississauga (CA); Kaveh KAHEN, North York (CA)

(21) Appl. No.: 18/293,245

(22) PCT Filed: Jan. 27, 2023
(86) PCT No.: PCT/CA2023/050118

§ 371 Date: Jan. 29, 2024

Related U.S. Application Data
(60) Provisional application No. 63/307,786, filed on Feb. 8, 2022.

(51) Int. Cl. H01J 49/00; H01J 49/06

(52) U.S. Cl. CPC H01J 49/0068; H01J 49/005; H01J 49/06

(57) ABSTRACT

A collision cell is disclosed that comprises of a support and a target material. The parent ions entering the cell are accelerated and collide with the target material resulting in their fragmentation. The target material can be made from any suitable materials such as graphene, carbon, silicon, a combination of these materials, or alloys which have an atomic or molecular structure. The target material and the support are so selected to optimize the fragmentation process for a particular range of molecules and ions. The fragmented ions produced within the collision or fragmentation zone are focused and collected by a set of lenses positioned on the downstream side of the cell.

### FIELD OF INVENTION

The present invention generally relates to mass spectrometry and particularly to a collision cell in mass spectrometer.

### BACKGROUND OF THE INVENTION

Mass spectrometers are used for elemental and molecular analysis. They are versatile and accurate devices for detecting and studying atoms and molecules by means of their mass-to-charge ratio. One type of this technology is called tandem mass spectrometer which has become the preferred method of choice for many applications. Tandem mass spectrometry allows selection and isolation of specific compounds of interest and their subsequent identification. Its extra selectivity enables this technology to be used for quantification of target compounds even in the presence of complex matrices. A typical tandem mass spectrometer comprises of two mass analyzers or filters arranged in series with a collision cell arranged in between them. The first mass analyzer transmits parent ions from the ionization source that have a particular mass to charge ratio. These ions then enter the collision cell with appropriate energy to fragment the parent ions transmitted by the first mass analyzer. Then the second mass analyzer receives and filters the fragmented ions by the collision cell. Eventually, only the ions of interest reach the detector.

There are a variety of collision cells that use different techniques to fragment molecules. The most commonly used type is the gas-based collision cell, in which the cell is filled with a suitable gas and sustained at a few mTorr of pressure. The parent ions, selected by the first mass analyzer, enter the collision cell and undergo energetic collisions with gas molecules. The energy absorbed by these collisions dissipates into the internal structure of the incoming molecules. If this energy is enough to break any bonds, the ions will go through fragmentation. This process is called collision-induced-dissociation (CID). The second mass analyzer is arranged to analyze the products of the fragmentation process. The processes of mass selection, fragmentation, and product ion mass analysis take place sequentially.

Another type of collision cell is surface induced dissociation (SID). In this case the molecules are accelerated towards a hard, impenetrable surface and collide with it for fragmentation. In this case, in contrast to CID which uses gas molecules for the purpose of fragmenting molecules, collision with the hard surface induces fragmentation. This process is not very efficient as it causes the incident fragmented ions to scatter and only a limited number of ions can be detected.

There are several limitations associated with gas-based CID. The first issue is that the cell needs to be pressurized with a collision gas. In tandem mass spectrometry, the collision cell is placed inside the high vacuum section of the mass spectrometer where the pressure needs to be kept in the microTorr levels for the mass analyzers to be able to perform effectively. Pressurizing the collision cell with gas would require larger turbomolecular pumps and roughing pumps to keep the pressure in the microTorr region. This contributes to the size and unit price of the mass spectrometer.

On the other hand, for the fragmentation process to take place effectively, the parent ions need to experience a minimum number of collisions within the collision cell. Therefore, gas-based collision cells have to be long enough to allow for enough collisions to happen. In addition, to prevent loss of fragmented molecules, flow focusing elements are needed, which add to length and complexity of the system. Therefore, current mass spectrometers are relatively long, and it is difficult to build a compact mass spectrometer without addressing the limitations imposed by the collision cell.

Another issue with the gas-based fragmentation is that they cannot fragment large molecules such as proteins and peptides. It is difficult to transfer enough energy from such collisions to large molecules. The efficiency of fragmentation in such collisions is very low. In addition, large molecules have several degrees of freedom, and the energy transferred during the collision is distributed among all different degrees of freedom reducing the effective energy transfer to each bond.

The objective of the present invention is to eliminate these issues and to make a small and compact mass spectrometer.

### SUMMARY OF THE INVENTION

A completely new collision cell, called Solid Target Collision Cell (STCC), is disclosed here which comprises of a support which is coated or mounted with one to several atomic layers of a suitable target material. An ion beam moving towards the support is accelerated towards the support, for example, by an applied potential connected to the support. Ions collide with the first few layers of the target material placed on the support and undergo fragmentation. The ions lose their radial and axial energy by subsequent collisions while passing through the target material, and finally emerge from the other side of the support with very low energy. The fragmented ions are then extracted and focused by the aid of an aperture lens, an RF multi-pole ion guide, a stack of lenses, or any other means of extraction and focusing methods. The target material can be made from carbon, silicon, a type or combination of these materials, or any other suitable elements, compounds, or alloys which may have an atomic or molecular structure. This solid-target collision cell allows for tandem mass spectrometers to be made significantly smaller, much more cost-effective, and also portable. Since the need for a collision gas is removed (as in gas-based collision cell), the size of the vacuum pumps can also be drastically reduced which again leads to a more compact, portable mass spectrometer.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows different parts of a typical tandem mass spectrometer.

FIG. 2A shows the process of fragmentation of molecular ions as they go through a conventional collision cell.

FIG. 2B shows the cross-sectional view of the same collision cell.

FIG. 3 shows an alternative technique to gas-based CID that currently exists, Surface Induced Dissociation (SID).

FIG. 4 shows one embodiment of the present collision cell.

FIG. 5 shows the target material may also be coated on the structure of the support.

FIG. 6 shows another embodiment of the present invention in which the solid target collision cell (STCC) is used in a tandem mass spectrometer.

FIG. 7 shows a mechanism that provides a selection of different target materials to serve as collision cell for various applications.

FIG. 8 shows an embodiment of the present device which has an extraction (ion) lens that is placed at the downstream side of the mesh to extract and focus the fragmented ions.

FIG. 9 shows another embodiment of the present device in which a stack of extraction lenses is used to collect the fragmented ions and increase the extraction and focusing efficiency.

FIG. 10 shows another embodiment of the present device in which an ion guide is used to focus the fragmented particles.

FIG. 11 shows another embodiment of the present device in which an Einzel extraction lens is used to collect the fragmented ions.

FIG. 12 shows another embodiment of the present device in which an enclosure is coupled with the solid target collision cell.

### DETAILED DESCRIPTION

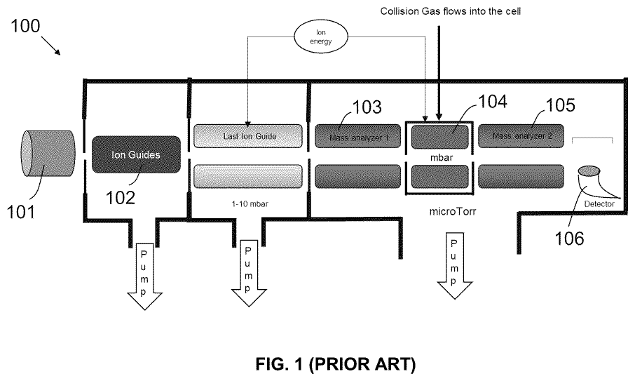

FIG. 1 shows different parts of a typical tandem mass spectrometer 100 which comprises of an ionization source 101, a set of ion guides 102 (for example, RF-only quadrupole ion guides) or ion focusing lenses, a first quadrupole mass analyzer 103, a collision cell 104, a second quadrupole mass analyzer 105, followed by an ion detector 106. The quadrupole mass analyzers 103, 105 (or mass filters) are typically used to transmit ions having a specific mass to charge ratio. Any other mass analyzers can be used, such as sector field, time-of-flight, ion mobility, ion trap, orbitrap, Fourier-transform ion cyclotron resonance, etc.

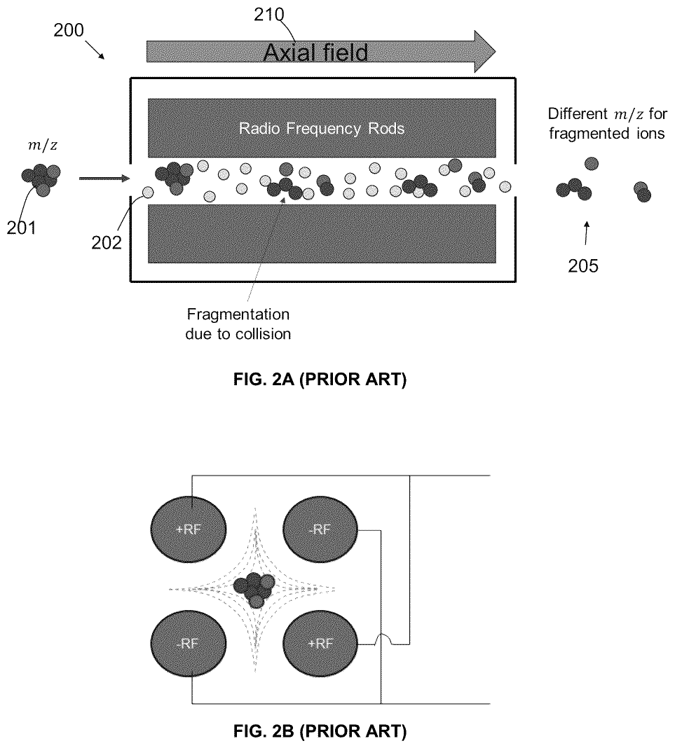

In a conventional gas-based collision cell 200, as in FIG. 2, ions undergo multiple energetic collisions with background gas molecules in order to induce fragmentation. Several collisions are required for the fragmentation process to take place effectively and a few subsequent collisions are needed for focusing to happen. The number of collisions that each ion experiences depends on the mean free path λ of the flow. Mean free path in turn is inversely proportional to the cross section σ of the ions and the pressure inside the collision cell through number density n:

$$λ = \frac{1}{σ \times n}$$

As shown in FIGS. 2A and 2B, molecular and atomic ions 201 are accelerated into the gas-based collision cell (C.C.) 200 to collide with the molecules of a target gas 202 within the C.C. 200. In this context, a target thickness, t, is defined as the length of the C.C., L, times the number density, n, of the collision gas (which is directly proportional to the pressure P inside the C.C.):

$$t = L \times n ; n = \frac{P}{{k}_{B} T} \to t = \frac{L \times P}{{k}_{B} T}$$

Ions may gain energy as a result of the collisions with molecules or atoms of the collision gas. This energy distributes in the entire structure of the molecule. If the deposited energy exceeds the energy of a certain bond, it will break that bond and hence the molecule will undergo the fragmentation process, generating fragmented ions 205. This process is known as Collision Induced Dissociation (CID).

In addition, in most cases, elaborate and costly components and electrical circuit design are also implemented in the mass spectrometer to form an axial field 210 inside the collision cell to be able to move the ions faster through the collision cell (see FIG. 2A). This is a necessary technique for fast scanning of the analytes.

FIG. 2A shows the process of fragmentation of molecular ions as they go through a conventional collision cell. If the amount of dissipated energy exceeds the energy of more than one bond, the ions produce more fragments. Therefore, by adjusting the incoming ion energy and pressure within the C.C. the degree of fragmentation can be controlled. Since the fragmentation pathways of these molecules are unique, this process can provide essential information regarding the quantity and structure of the molecules.

As shown in FIG. 2B (which shows the cross-sectional view of the same collision cell), normally fragmentation occurs at the presence of a radio-frequency-only (RF) confinement field in order to contain the ions and prevent them from radial scattering. Fragmented ions under the influence of the RF confinement field and subsequent collisions lose their radial and axial energy. The RF field then confines the ions around the central axis of the cell. This phenomenon is known as “collisional focusing”.

Some of the major drawbacks of the gas-based CID technique are as follows. By design, a certain number of collisions are required to happen inside the gas-based collision cell to fragment the ions. In addition, further collisions are required for the collisional focusing to take place effectively. Therefore, gas-based collision cells are typically designed to be around 15-20 cm long. Reducing the length of the collision cell below these values, will compromise the performance of the cell. Needless to say, the design of the collision cell and the required electronic circuits are complicated and costly. For example, a complicated RF power supply is required to drive the RF-only ion guides within the collision cell.

In addition, since the cell is pressurized with a gas, using large vacuum pumps is necessary to remove the collision gas and sustain the pressure in the microTorr levels within the vacuum chamber of the mass spectrometer. This is necessary for the functionality of the mass analyzers. Plus, complicated flow controlling systems are required to accurately control the flow of collision gas into the collision cell. Naturally a gas supply is also required to be connected to the mass spectrometer for this purpose. These are the main impediments against reducing the cost and size of tandem mass spectrometers as well as making them portable.

The gas-based collision cell is also incapable of fragmenting large molecules such as proteins and peptides. Smaller diatomic and triatomic molecules also do not fragment easily because of their low collision cross-section or longer mean free path which prevent them from experiencing enough collisions to fragment and subsequent collisional focusing.

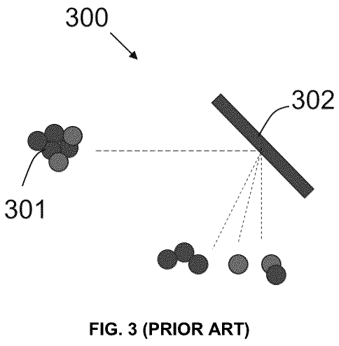

An alternative technique to gas-based CID that currently exists is Surface Induced Dissociation (SID) 300, as schematically shown in FIG. 3. In this method, ions 301 are accelerated toward a hard, impenetrable target surface 302. Molecular ions are fragmented as a result of the collision with the hard surface. While this method is capable of fragmenting large molecule to some degree and is relatively smaller in size, the major drawback with this technique is its very low fragmentation efficiency. Also, it is difficult to contain the fragmented ion and prevent them from scattering after the collide with the surface.

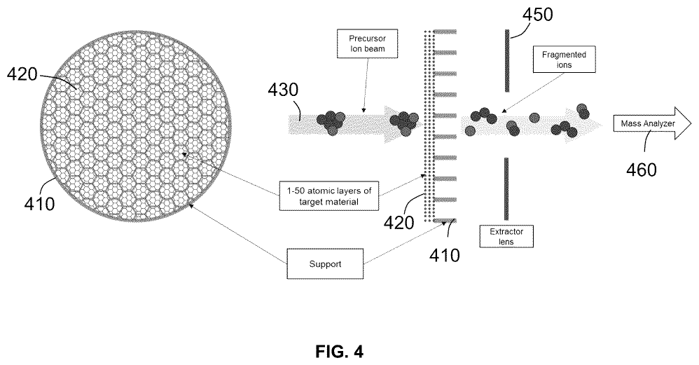

Herein, we introduce a novel method for ion fragmentation, which addresses the limitations mentioned above. FIG. 4 shows the front and side views of one embodiment of the present collision cell. The cell is primarily comprised of a support 410 in the form of a mesh, a grid, a grating with micro-or nanostructure openings, a porous substrate, or a porous support membrane with a certain pore size and diameter.

The mesh may be made of various materials such as copper, gold, silver, steel, nickel, stainless steel, titanium, molybdenum, aluminum or any other metal, alloy, or a combination of them. The mesh size may be in the range of 10 to 15000 with various thicknesses, for example in the range of 10 nm to a 10 millimeters. The mesh or grid may have openings of any size or shape, for example circular, hexagonal, rectangular, slot-shaped, triple-slot, various apertures, or any other form or geometry. The size of the openings may be in the range of 6000 microns to less than 2 nanometers. The porous support may be made from layers of graphene, carbon, silicon dioxide, silicon nitride or a combination or amalgamation of these materials. The silicon nitride support may be of the holey type. The carbon support may be of the holey or lacey type.

The collision cell further comprises of a number of layers of a target material 420 of a suitable material deposited, mounted, coated, or fixed on top of the mentioned support. The number of layers can be in the range of 1 to 100 atomic layers. The choice of the target material is important and may depend on the molecular or atomic ions of interest. The target material can for example be one or a few layers of graphene fixed on top of each other and on top of the support.

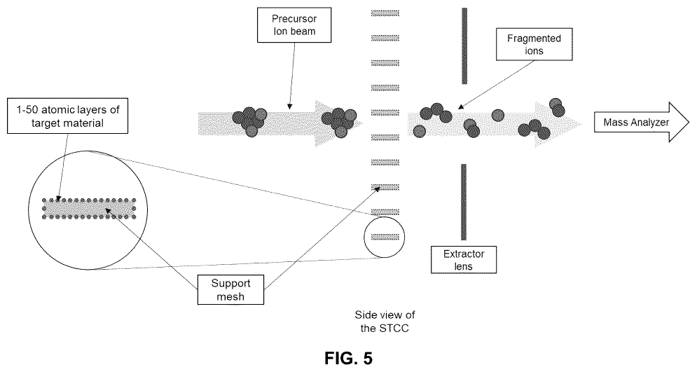

FIG. 5 shows another embodiment of the present invention, in which the target material 520 is coated on the structure of the support 510, in contrast to mounting layers of the target material on the structure as in the previous embodiment The inset shows a magnified view of the cross-section of the mesh in which a few layers of the target material is coated on the mesh structure. For example, surface of the mesh may be coated with a few atomic layers of a suitable material, for example, carbon, silicone, or any other material. Various deposition processes may be chosen to coat the mesh structure with the target material. In this manner, instead of going through the target material as in the previous embodiment, the molecules will interact with the target material when they hit the support structure or mesh as they go through the mesh.

Some examples are chemical vapor deposition, physical vapor deposition, sputtering, aerosol deposition, hybrid physical-chemical vapor deposition, ion plating, thin film deposition, ion beam-assisted deposition, chemical deposition, spraying, thermal spray, or a combination of these methods or any other suitable methods.

In any case, the openings or porosity of the target material should be chosen properly to make sure the incoming ions experience a minimum number of collisions with its atoms or molecules, while allowing the fragmented ions to pass through at the same time. Also, the openings of the support should be large enough to allow the fragmented ions to pass through and not impede the flow of the ion beam.

As shown in FIG. 4, in one embodiment of the present invention, an ion beam 430 moving towards the support can be accelerated toward the support, for example, by an applied potential connected to the support. The ions collide with the first few layers of the target material placed on the support and undergo fragmentation. The ions lose their radial and axial energy by subsequent collisions with the subsequent atomic layers of the target material while passing through the support, and finally emerge from the other side of the support with very low energy. The fragmented ions are then extracted and focused, for example, by the aid of an aperture lens 450, an RF multi-pole ion guide, a stack of lenses, or any other means of extraction and focusing methods. FIG. 4 shows one embodiment of the present invention wherein an extraction lens is used to extract the fragmented ions and direct them toward the mass analyzer 460.

The target material can be made from graphene, carbon, silicon, a type or combination of these materials, or any other suitable elements, compounds, or alloys which may have an atomic or molecular structure. In the case of carbon, the target material may be of the holey or lacey type. In the case of graphene, the target may be comprised of a single layer of graphene, 2 to 10 layers, or multiple layers, based on the nature of the analyte ions and the application.

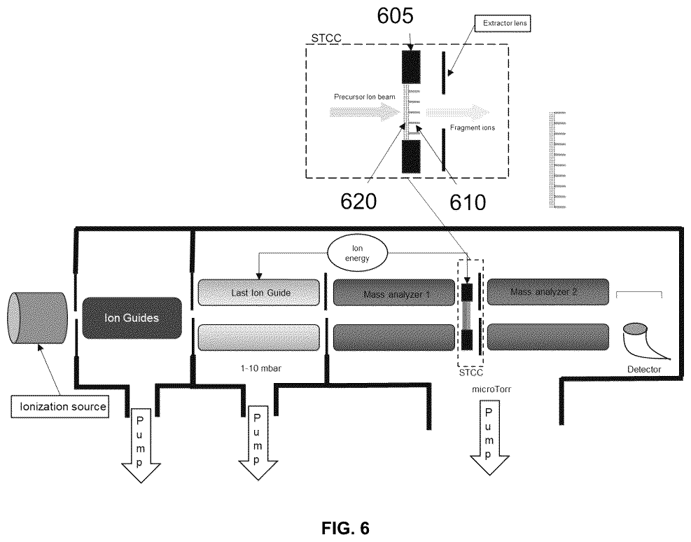

FIG. 6 shows another embodiment of the present invention in which the solid target collision cell (STCC) is used in a tandem mass spectrometer. The physical size of the present collision cell is significantly smaller than the prior-art gas-based collision cells. A retaining ring 605 may be used to hold the support 610. One or more atomic layers of a target material 620 is deposited on the support. The support is placed in the flow path of the ion beam. An extractor lens is placed at the downstream side of the collision cell. In this case, when molecules and ions are accelerated towards the support, the target material acts as a collision cell while the fragmented ions can pass through the support without interfering with it. Ions from an ion source are transmitted to the first quadrupole mass analyzer. The first quadrupole mass analyzer is arranged to transmit parent or precursor ions having a particular or desired mass to charge ratio and to block all other ions having different or undesired mass to charge ratios. The parent or precursor ions selected by the first quadrupole mass analyzer are transmitted to the collision cell. The parent ions fragment into daughter ions by colliding with the target material while passing through the collision cell. The resulting fragment or daughter ions leave the collision cell to the second quadrupole mass analyzer. Daughter or fragmented ions having a particular mass to charge ratio are then selected by the second quadrupole mass analyzer and eventually reach the ion detector. The energy of the ions entering to and colliding with the collision cell may be controlled, for example, by adjusting the applied potential between the collision cell (e.g., the support) and the preceding components of the mass spectrometer, for example the first quadrupole mass analyzer.

The ionization source for the tandem mass spectrometer may be for example an electrospray ionization source, an electron impact source, an inductively coupled plasma source, an atmospheric pressure chemical ionization source, an atmospheric pressure photo-ionization source, a plasma source, or any other type of combination of ionization sources based on the application.

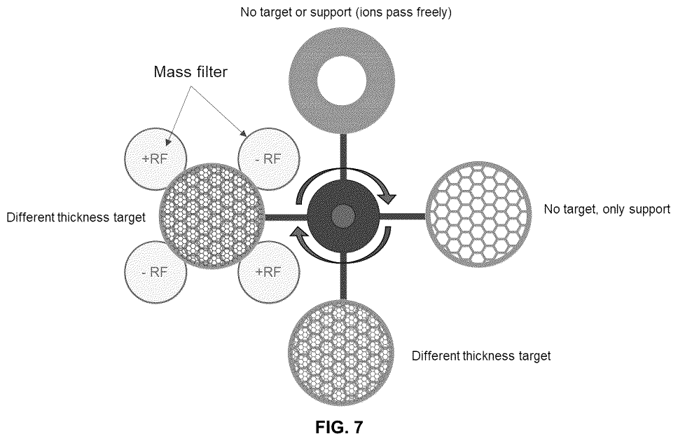

The size of the proposed collision cell is significantly reduced compared with a gas-based collision cell. FIG. 7 shows a mechanism that provides a selection of different target materials to serve as collision cell for various applications. Different layers of target material can be mounted or coated on various supports. A carrousel 700 or a magazine of targets can be used to place the target of choice in front of the ion beam. Different thicknesses can be designed and employed simply by placing the collision cell in front of any incoming beam of ions. A selection mechanism 710, such as a switch, a servo motor, a step motor, or a mechanical handle can be used for this purpose to provide a selection of different targets with different thicknesses. For example, a suitable layer with a higher thickness can be designed for large or very small molecules. Possible thickness of the target can be as low as the thickness of single atom. For example, a single layer of graphene can be used for this purpose, with a thickness of approximately 0.345 nm. Alternatively, several layers of graphene can be used for this purpose.

The physical dimensions of the solid target C.C. can be slightly larger than the cross-sectional area of the ion beam. In most tandem mass spectrometers, the beam cross-section is about 1.0-10.0 mm in diameter. The thickness of the solid target C.C. can therefore be in the order of a few millimeters. This is a significant reduction in the size of collision cell compared with gas-based collision cells which are complicated, expensive devices and are normally designed to be around 15-20 cm long.

The support and the target material mounted on it are configured in a way to prevent them from being sputtered as a result of the incoming ion beam. Therefore, the target material may not be removed from the support.

The presently disclosed solid target collision cell, STCC, allows for the fragmentation of large molecules, such as proteins, lipids and peptides. Small molecules, such as diatomic and triatomic molecules, can also be readily fragmented. The tandem MS of the present disclosure requires much smaller pumping capacity for obtaining vacuum; it can be designed to be smaller and more cost-effective; it is simple, easy-to-build, cost-effective, and requires no elaborate design; it fits all types of tandem MS devices, and it provides more capability compared to gas-based or surface induced dissociation (SID) techniques. In addition, it requires no additional gas and flow controllers for maintaining the CC pressure, and therefore simplifies the MS device design.

The features, geometry, and properties of the support as well as the thickness, properties, and nature of the target material may be optimized for fragmentation of different types of ions and molecules. FIG. 7 shows replaceable collision cells. In this case, four different cells are arranged on a rotatable device, that can be easily rotated to place the desired cells in line with the ion beam. In addition, the coated target may be made of a variety of materials with different thicknesses. Different target thicknesses can be selected depending on the size of different molecules. A simple mechanism for selection of different target thicknesses can be designed including electrical switches and motors which places various STCCs in front of the ion beam. For example, for some cases, the target material may be optimized to fragment very large molecules. In another case, the target material may be adjusted to fragment smaller molecules. Also, for some applications, the support may lack any target materials. In this case, the ions will only interact with the support and its structure. Finally, the support may also be removed to let the intact ions pass through without any fragmentation.

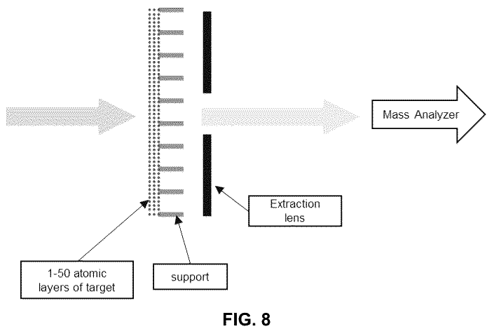

FIG. 8 shows an embodiment of the present device which has an extraction (ion) lens that is placed at the downstream side of the mesh to extract and focus the fragmented ions. A wide variety of ion lenses can be used to focus the ions.

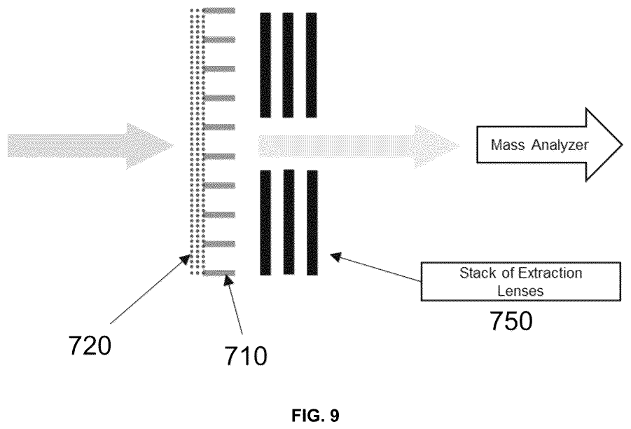

FIG. 9 shows another embodiment of the present device in which a stack of extraction lenses is used to collect the fragmented ions and increase the extraction and focusing efficiency.

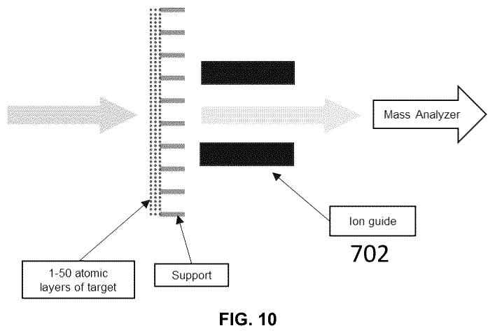

FIG. 10 shows another embodiment of the present device in which an ion guide 702 is used to focus the fragmented particles. An RF-only ion guide can be used in this case.

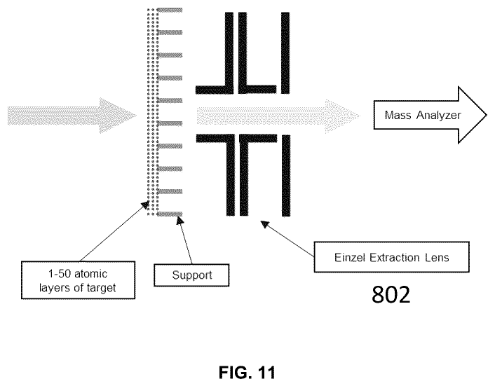

FIG. 11 shows another embodiment of the present device in which an Einzel extraction lens 802 is used to collect the fragmented ions.

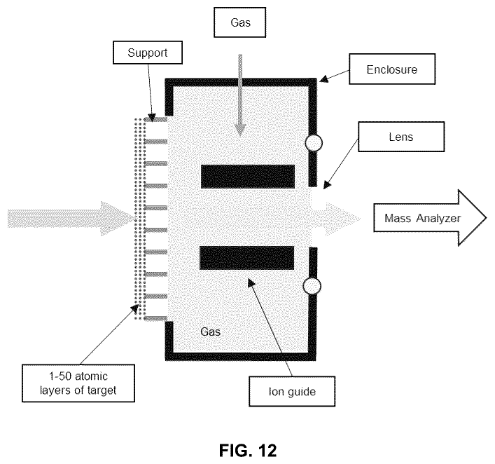

FIG. 12 shows another embodiment of the present device in which an enclosure is coupled with the solid target collision cell. In this case, the support and the target material are coupled with a chamber that is pressurized with a collision and/or reaction gas. A means is provided for introducing this gas into the enclosure. Ions colliding with and passing through the target material are arranged to also undergo gas-based collisions to induce further fragmentation resulting in a plurality of fragmented or daughter ions being generated. The enclosure can be filled with a neutral gas such as N₂ or Ar for further damping of the ions. The gas may also be used for ion-molecular reaction. As a result of the reaction between the fragmented ions emerging from the STCC and the reaction gas, new molecular species may form which have different mass to charge ratios. Therefore, they can be effectively separated and filtered using the second mass analyzer. This is another way that the interfering ions can be removed, or the ions of interest can be moved to a new mass to charge ratio in the mass spectrum which is free from any isobaric interferences.

In another case, the incoming ions may be atomic rather than molecular. In such a case, the solid target collision cell can be only used to reduce the energy of the incoming atomic ions. The ions can then go through ion/molecular reaction with the reaction gas to deal with isobaric interferences. The target material for the collision cell may also be used in a way to react with the incoming molecular or atomic ions. RF-only ion guide can then be provided to extract the fragmented ions or the new ion species as well confining them. Electrostatics lenses are also feasible for extraction and confinement of the ions.

1. A Solid Target Collision Cell (STCC) for mass spectrometry, comprising:
a) a support comprising of a mesh having a mesh size, a grid having an opening geometry and an opening size, a grating with micro-or nanostructure, a porous substrate with a predefined pore size, or a porous support membrane, and
b) a number of atomic layers of a target material coated, mounted or positioned on the support, wherein the target material is selected from a group consisting of graphene, carbon, silicon, metals, alloys having an atomic or molecular structure, or a combination of these materials,
wherein the support is placed in a flow path of an ion beam and ion fragmentation occurs when ions enter the support and collide with the target material, thereby the target material acts as a collision cell while fragmented ions pass through the support.

2. The system of claim 1, wherein the mesh is made of copper, gold, silver, steel, nickel, stainless steel, titanium, molybdenum, aluminum, metal, or metal alloy.

3. The system of claim 1, wherein the mesh size is in the range of 10 to 15000 and a mesh thickness is in the range of 10 nm to a few millimeters.

4. The system of claim 1, wherein the opening geometry of the grid is circular, hexagonal, rectangular, slot-shaped, or triple-slot shaped.

5. The system of claim 1, wherein the opening size of the grid is in the range of hundreds of microns to less than a few nanometers.

6. The system of claim 1, wherein the porous substrate is made from layers selected from a group consisting of graphene, carbon, silicon dioxide, or silicon nitride, and wherein silicon nitride is holey type and carbon is holey or lacey type.

7. The system of claim 1, wherein the number of atomic layers are in the range of 1 to 100 atomic layers.

8. The system of claim 1, wherein a thickness of the target material is in the range of single atom, and a single layer of graphene with a thickness of approximately 0.345 nm, or several layers of graphene.

9. The system of claim 1, further having a power source to apply a potential to the support to accelerate the ion beam towards the support, whereby ions collide with the target material and undergo fragmentation, and lose their radial and axial energy by subsequent collisions with the number of atomic layers of the target material while passing through the support, and emerge with a low energy.

10. The system of claim 1, further having an aperture lens, an Einzel extraction lens, an RF multi-pole ion guide, or a stack of lenses placed downstream of the support to extract and focus fragmented ions and direct them toward a mass analyzer.

11. The system of claim 1, wherein a retaining ring is used to hold the support.

12. The system of claim 1, wherein the solid target collision cell is coupled to a chamber that is pressurized with a collision and/or reaction gas, whereby ions colliding with and passing through the target material also undergo gas-based collisions and/or reactions to induce further fragmentation resulting in a plurality of fragmented ions, daughter ions, and/or product ions are generated.

13. The system of claim 12, wherein the collision and/or reaction gas is Nitrogen, Argon, air, Helium, Xenon, Hydrogen, Oxygen, ammonia, Sulfur hexafluoride, carbon dioxide, nitrous oxide, or a mixture of these gases.

14. The system of claim 1, wherein the support comprises of a carrousel or a magazine having a plurality of target materials, wherein each target material having a predefined thickness, and wherein the carrousel or the magazine is configured to change the target material using a switch, a servo motor, a step motor, or a mechanical handle to provide a selection of the target material with variable thicknesses.

15. The system of claim 1, having a replaceable solid target collision cell, wherein four solid target collision cells are arranged on a rotatable device that rotates to place each solid target collision cell in line with the ion beam.

16. The system of claim 1, wherein the target material is deposited by any one of chemical vapor deposition, physical vapor deposition, sputtering, aerosol deposition, hybrid physical-chemical vapor deposition, ion plating, thin film deposition, ion beam-assisted deposition, chemical deposition, spraying, or thermal spray.

17. A tandem mass spectrometer, comprising:
a) an ionization source;
b) a set of ion guides or ion focusing lenses;
c) a first mass analyzer or a mass filter to transmit ions having a specific mass to charge ratio, and to transmit parent or precursor ions having a particular or desired mass to charge ratio and to block all other ions having different or undesired mass to charge ratios;
d) a solid target collision cell comprising:
i) a support in the form of a mesh, a grid, a grating with micro-or nanostructure openings, a porous substrate, or a porous support membrane with a certain pore size and diameter, and
ii) a target material mounted, positioned, or coated on the support, wherein the target material is selected from a group consisting of graphene, carbon, silicon, metals, alloys which may have an atomic or molecular structure, or a combination of these materials,
whereby the parent or precursor ions selected by the first mass analyzer are transmitted to the collision cell;
e) a second mass analyzer, wherein said parent or precursor ions fragment into daughter ions by colliding with the target material while passing through the collision cell, the resulting fragment or daughter ions leave the collision cell to the second mass analyzer, and daughter or fragmented ions having a particular mass to charge ratio are then selected by the second mass analyzer and eventually reach the ion detector, and wherein the energy of the ions entering to and colliding with the collision cell is controlled by adjusting the applied potential between the collision cell and the preceding components of the mass spectrometer,
f) an ion detector,
whereby the openings or porosity of the target material are chosen to make sure the incoming ions experience a minimum number of collisions with its atoms or molecules, while allowing the fragmented ions to pass through at the same time, and whereby the openings of the support are large enough to allow the fragmented ions to pass through and not impede the flow of the ion beam.

18. The system of claim 17, wherein the first or the second mass analyzers is any one of quadrupole, sector field, time-of-flight, ion mobility, ion trap, orbitrap, or Fourier-transform ion cyclotron resonance.

19. The system of claim 17, wherein the ionization source for the tandem mass spectrometer is selected from the group consisting of an electrospray ionization source, an electron impact source, an inductively coupled plasma source, an atmospheric pressure chemical ionization source, an atmospheric pressure photo-ionization source, and a plasma source.

20. The system of claim 17, wherein the solid target collision cell is coupled to a chamber that is pressurized with a collision and/or reaction gas, whereby ions colliding with and passing through the target material also undergo gas-based collisions and/or reactions to induce further fragmentation resulting in a plurality of fragmented ions, daughter ions, and/or product ions are generated.
